(19) United States
(12) Patent Application Publication
(10) Pub. No.: US 2004/0191496 A1
(43) Pub. Date: Sep. 30, 2004

(54) Coated microporous sheets

(76) Inventors: Brian K. Rearick, Allison Park, PA (US); Victoria A. Trettel, Freeport, PA (US); Christina A. Winters, Freeport, PA (US); Jonathan T. Martz, Glenshaw, PA (US)

Correspondence Address: PPG INDUSTRIES, INC., Intellectual Property Department, One PPG Place, Pittsburgh, PA, 15272, US

(21) Appl. No.: 10/395,566

(22) Filed: Mar. 24, 2003

(51) Int. Cl. B32B 3/26; B32B 3/00; B32B 9/00

(52) U.S. Cl. 428/304.4; 428/318.4

(57) ABSTRACT

Microporous sheets coated with substantially solvent-free, water-based coating compositions are disclosed. The coating compositions may comprise film-forming resins such as polyurethanes, acrylics and polyesters, and may further comprise pigments, crosslinkers, standard additives and the like. The coated microporous sheets exhibit favorable visual and mechanical properties, including high levels of elongation. The coated microporous sheets of the present invention may be applied to substrates by techniques such as injection molding and compression molding. The ability of the coated microporous sheets to withstand substantial elongation permits their use in high draw, in-mold applications.

### FIELD OF THE INVENTION

The present invention relates to coated microporous sheets. More particularly, the invention relates to substantially solvent-free, water-based coatings for microporous sheets which provide good visual characteristics and improved mechanical properties. The coated sheets are useful for many applications such as high-draw in-mold laminated products.

### BACKGROUND INFORMATION

Laminated films have been used as substitutes for traditional painting applications. For example, vinyl and polycarbonate layers have been laminated to various substrates to provide decorative and protective layers. Laser printed microporous sheets have also been laminated to polymeric substrates in order to provide decorative layers.

Microporous sheets comprise a matrix of thermoplastic organic polymer, particulate filler and interconnecting pores. An example of a microporous sheet comprises polyethylene and silica filler particles sold under the designation Teslin® by PPG Industries, Inc. Microporous sheets are useful in many applications such as cards, tags, labels, menus, in-mold graphics, commercial printing and specialty printing.

It would be desirable to use coated or painted microporous sheets for in-mold applications in which a coated or painted sheet is laminated to a substrate by techniques such as injection molding or compression molding. However, such molding operations can destroy the painted microporous sheets, particularly in high-draw molding processes where severe elongation and deformation of the sheets occurs.

Accordingly, there is a need for coated microporous sheets which possess good visual characteristics and which are capable of withstanding substantial deformation.

### SUMMARY OF THE INVENTION

The present invention provides water-based coatings for microporous sheets. The coatings are preferably substantially solvent-free and comprise resins such as polyurethanes, acrylics, polyesters, polyethers, polyamides, epoxies and/or vinyls, and exhibit favorable mechanical properties when applied to microporous sheets. The coated microporous sheets of the present invention may be used for applications in which a coated sheet is laminated to a substrate by techniques such as injection molding, compression molding, stamping, hand lay-up molding, spray-up molding, prepreg molding, resin transfer molding, structural reaction injection molding, blow molding, rotational molding, thermoplastic extrusion, pultrusion or thermoforming. The coated microporous sheets may be laminated to various polymeric substrates without the use of a supplementary adhesive layer.

An aspect of the present invention is to provide a microporous sheet coated with a water-based resin coating. The water-based resin coating may comprise polyurethane and is preferably substantially free of organic solvents.

Another aspect of the present invention is to provide a coated microporous sheet having favorable elongation properties, e.g., an elongation at break of at least 50 percent.

A further aspect of the present invention is to provide a method of coating a microporous sheet comprising applying a substantially solvent-free, water-based resin coating composition on the microporous sheet.

Another aspect of the present invention is to provide a laminated article comprising a substrate and a microporous sheet coated with a water-based resin coating adhered to the substrate.

A further aspect of the present invention is to provide a method of making a laminated article. The method comprises adhering a microporous sheet coated with a water-based resin coating to a substrate.

These and other aspects of the present invention will be more apparent from the following description.

### BRIEF DESCRIPTION OF THE DRAWINGS

FIG. 1 is a partially schematic side view of a microporous sheet coated with a substantially solvent-free, water-based coating in accordance with an embodiment of the present invention.

FIG. 2 is a partially schematic side view of a microporous sheet coated with a substantially solvent-free, water-based coating and a protective layer in accordance with another embodiment of the present invention.

FIG. 3 is a partially schematic side sectional view illustrating a compression molding process incorporating a coated microporous sheet in accordance with an embodiment of the present invention.

FIG. 4 is a partially schematic side sectional view illustrating an injection molding process incorporating a coated microporous sheet in accordance with another embodiment of the present invention.

### DETAILED DESCRIPTION

The present invention provides water-based coatings for microporous sheets. The coating composition may be substantially solvent-free and possess improved elongation properties. The coatings may comprise resins such as polyurethanes, acrylics, polyesters, polyethers, polyamides, epoxies, vinyls and the like.

As used herein, the term “coating” means a material that forms a continuous surface layer or film on a microporous sheet. A portion of the coating may penetrate at least partially into the pores of the microporous sheet.

The term “substantially solvent-free” as used herein means that the coating composition contains less than about 15 or 20 weight percent organic solvents, preferably less than 5 or 10 weight percent, with weight percent being based on the total weight of the coating composition to be applied to the microporous sheet. For example, the coating composition may contain from zero to 2 or 3 weight percent organic solvents.

The term “water-based” as used herein means coating compositions in which the carrier fluid of the composition is predominantly water on a weight percent basis, i.e., more than 50 weight percent of the carrier comprises water. The remainder of the carrier comprises less than 50 weight percent organic solvent, typically less than 25 weight percent, preferably less than 15 weight percent. Based on the total weight of the coating composition (including the carrier and solids), the water may comprise from about 20 to about 80 weight percent, typically from about 30 to about 70 weight percent, of the total composition.

The water-based coating compositions of the present invention comprise resins such as polyurethanes, acrylics, polyesters, polyethers, polycarbonates, polyamides, epoxies, vinyls and the like. Any resin that forms a suitable film and is compatible with water-based compositions can be used in accordance with the present invention, absent compatibility problems. Examples of polymers useful in forming the resin may include hydroxyl or carboxylic acid-containing acrylic copolymers, hydroxyl or carboxylic acid-containing polyester polymers, oligomers and isocyanate or hydroxyl-containing polyurethane polymers, and amine or isocyanate-containing polyureas. Some resins that may be suitable for use in the present coating compositions are described in U.S. Pat. No. 5,939,491, which is incorporated by reference herein.

The film-forming resin is generally present in the coating in an amount greater than about 20 weight percent, such as greater than about 40 weight percent, and less than 90 weight percent, with weight percent being based on the total solid weight of the cured coating. For example, the weight percent of resin can be between 20 and 80 weight percent.

Suitable polyurethane resins are formed from a polyisocyanate, an active hydrogen-containing material (polyols, polyethers, polyesters, polycarbonates, polyamides, polyurethanes, polyureas, polyamines and mixtures thereof), an acid functional material having a functional group reactive with isocyanate and optionally a polyamine. In one embodiment, the polyurethane has a weight average molecular weight of about 25,000 to 100,000, or even higher. Suitable acrylic resins include ethylene unsaturated monomers (vinyl and acrylic) prepared through emulsion polymerization. Suitable polyester resins include polyfunctional acids, polyhydric alcohols and monocarboxylic acids. Other suitable resins include hybrids or mixtures of any of these resins, i.e., acrylic/polyurethane or acrylic/polyester).

In addition to the above-noted resins, the present coating compositions may optionally include other ingredients such as cross-linkers, pigments, tints, colorants, fillers, extenders, UV absorbers, light stabilizers, plasticizers, rheology modifiers, surfactants, thickeners and wetting agents in a total amount of up to 80 weight percent based on the total weight percent of the coating composition to be applied to the microporous sheet.

Suitable curing agents or cross-linkers include carbodiimides, melamines, formaldehydes and isocyanates. Water-based carbodiimides, isocyanates and melamines may be preferred in some applications because they do not add significant amounts of organic solvents into the coating compositions. When a cross-linker is used, it is generally present in an amount of up to about 50 weight percent, based on the total solid weight of the cured coating.

The cross-linkers may be activated upon application of the coating composition to the microporous sheet. Alternatively, the cross-linkers may be activated during subsequent molding operations, such as compression molding or injection molding, where the elevated temperatures experienced during the molding operations are used to activate the cross-linkers. In this case, the cross-linkers may be partially activated upon application to the substrate, and fully cross-linked during the subsequent molding operation. Some cross-linkers that may be suitable for the present resins are described in U.S. Pat. No. 5,939,491. Combinations of crosslinkers can be used.

Suitable pigments include standard inorganic and organic pigments, such as those found in conventional paints. For example, various colored pigments are listed in the Dry Color Manufacturers Association (DCMA) classifications. Suitable tints include pigments dispersed in water-based or water miscible carriers. Some commercially available water-based tints include AQUA-CHEM 896 from Degussa, and Charisma Colorants and Maxitoner Industrial Colorants from Accurate Dispersions division of Eastman Chemical. The amount of pigment, tint and/or colorant may be selected depending upon the particular application, and may generally be present in an amount of up to 80 weight percent, based on the solid weight of the cured coating.

As used herein, the term “microporous sheet” means a sheet comprising a polymer matrix and an interconnecting network of pores. The matrix of the microporous sheet may comprise substantially water-insoluble thermoplastic organic polymer. Many kinds of such polymers are suitable for use as the matrix. In general, any substantially water-insoluble thermoplastic organic polymer which can be extruded, calendered, pressed or rolled into film, sheet, strip or web may be used. The polymer may be a single polymer or it may be a mixture of polymers. The polymers may be homopolymers, copolymers, random copolymers, block copolymers, graft copolymers, atactic polymers, isotactic polymers, syndiotactic polymers, linear polymers or branched polymers. When mixtures of polymers are used, the mixture may be homogeneous or it may comprise two or more polymeric phases.

Examples of classes of suitable substantially water-insoluble thermoplastic organic polymers of the microporous sheets include the thermoplastic polyolefins, poly(halo-substituted olefins), polyesters, polyamides, polyurethanes, polyureas, poly(vinyl halides), poly(vinylidene halides), polystyrenes, poly(vinyl esters), polycarbonates, polyethers, polysulfides, polyimides, polysilanes, polysiloxanes, polycaprolactones, polyacrylates, and polymethacrylates. Hybrid classes, for example, thermoplastic poly(urethane-ureas), poly(ester-amides), poly(silane-siloxanes), and poly(ether-esters) are within contemplation. Examples of specific substantially water-insoluble thermoplastic organic polymers include thermoplastic high density polyethylene, low density polyethylene, ultrahigh molecular weight polyethylene, polypropylene (atactic, isotactic, or syndiotactic), poly(vinyl chloride), polytetrafluoroethylene, copolymers of ethylene and acrylic acid, copolymers of ethylene and methacrylic acid, poly(vinylidene chloride), copolymers of vinylidene chloride and vinyl acetate, copolymers of vinylidene chloride and vinyl chloride, copolymers of ethylene and propylene, copolymers of ethylene and butene, poly(vinyl acetate), polystyrene, poly(omega-aminoundecanoic acid) poly(hexamethylene adipamide), poly(epsilon-caprolactam), and poly(methyl methacrylate).

The microporous sheets of the present invention may further comprise filler particles. For example, the microporous sheets can also comprise finely divided, substantially water-insoluble particulate filler, which may comprise, for example, siliceous and/or non-siliceous particles. The filler particles, when used, typically comprise at least 30 or 40 weight percent of the microporous material up to about 70 or 80 weight percent. In one embodiment, the filler particles are the predominant component of the sheet in comparison with the polymer matrix on a weight percent basis. Thus, the filler particles may comprise greater than 50 weight percent of the combined total of the polymer matrix and filler particles. For example, the filler particles may comprise greater than 60 weight percent.

A preferred particulate filler is finely divided substantially water-insoluble siliceous particles. Examples of suitable siliceous particles include particles of silica, mica, montmorillonite, kaolinite, asbestos, talc, diatomaceous earth, vermiculite, natural and synthetic zeolites, cement, calcium silicate, aluminum silicate, sodium aluminum silicate, aluminum polysilicate, alumina silica gels, and glass particles. Of the silicas, precipitated silica, silica gel or fumed silica may be particularly suitable.

Examples of non-siliceous filler particles include particles of titanium oxide, zinc oxide, antimony oxide, zirconia, magnesia, alumina, zinc sulfide, barium sulfate, strontium sulfate, calcium carbonate, magnesium carbonate, magnesium hydroxide, and finely divided substantially water-insoluble flame retardant filler particles such as particles of ethylenebis(tetra-bromophthalimide), octabromodiphenyl oxide, decabromodiphenyl oxide, and ethylenebisdibromonorbornane dicarboximide.

The filler particles typically have an average particle size of less than 40 micrometers. In the case of precipitated silica, the average ultimate particle size (irrespective of whether or not the ultimate particles are agglomerated) may be less than 0.1 micrometer.

Minor amounts, usually less than 5 percent by weight, of other materials used in processing such as lubricant, processing plasticizer, organic extraction liquid, water and the like may optionally also be present. Additional materials introduced for particular purposes may optionally be present in the microporous material in small amounts, usually less than 15 percent by weight. Examples of such materials include antioxidants, ultraviolet light absorbers, reinforcing fibers such as chopped glass fiber strand and the like.

The microporous sheets also comprise a network of interconnecting pores which communicate substantially throughout the material. On a coating-free basis, the pores typically constitute from 30 to 95 volume percent of the microporous material. For example, the pores may constitute from 60 to 75 percent by volume of the microporous material. On a coating-free basis, the volume average diameter of the pores may be at least 0.02 micrometers, typically at least 0.04 micrometers. The volume average diameter of the pores is also typically less than 0.5 micrometers.

Some examples of microporous sheets are disclosed in U.S. Pat. Nos. 4,833,172; 4,861,644 and 6,114,023, which are incorporated herein by reference. Commercially available microporous printing sheets are sold under the designation Teslin® by PPG Industries, Inc.

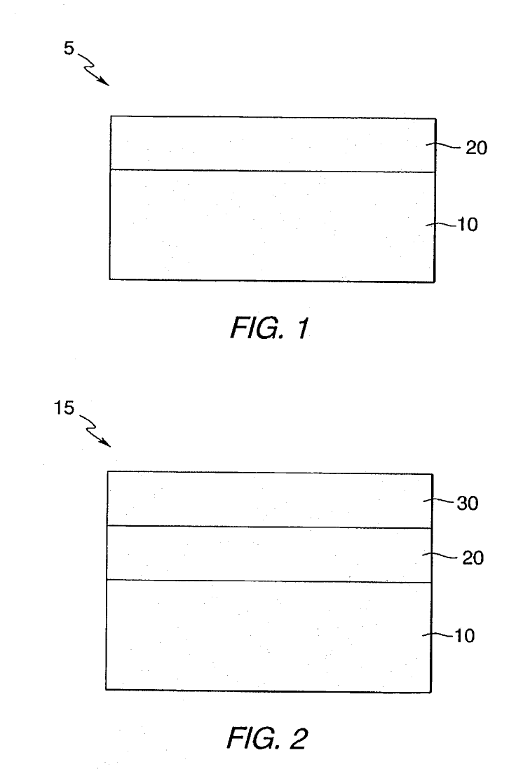

FIG. 1 illustrates a coated microporous sheet 5 comprising a microporous sheet 10 with a water-based coating 20. The coating 20 has a dry film thickness T that can range from 0.1 to 10 mils or more. For example, the dry film thickness T may be from 0.2 to 5 mils or 0.5 to 2 mils. Although the coating 20 is shown as a continuous layer or film on the surface of the sheet 10 in FIG. 1, at least a portion of the coating 20 may penetrate into the microporous sheet 10. In a preferred embodiment, the coating 20 does not completely fill the pores of the microporous sheet 10, such that the interconnected pore structure is maintained throughout at least a portion of the sheet. The coating 20 may be adhered directly to the microporous sheet 10. Although not required for many applications, a primer (not shown) may be used between the coating 20 and the microporous sheet 10.

FIG. 2 illustrates a coated microporous sheet 15 comprising a microporous sheet 10 with a coating 20 and an additional layer 30. The layer 30 may be a protective layer, which generally refers to a coating layer such as a clearcoat that imparts some protection to coating layer 20, such as QUV protection, or that impartsa quality that the coating layer 20 may not have, such as scratch resistance. Layer 30 may be applied on the coating 20 by any suitable conventional technique.

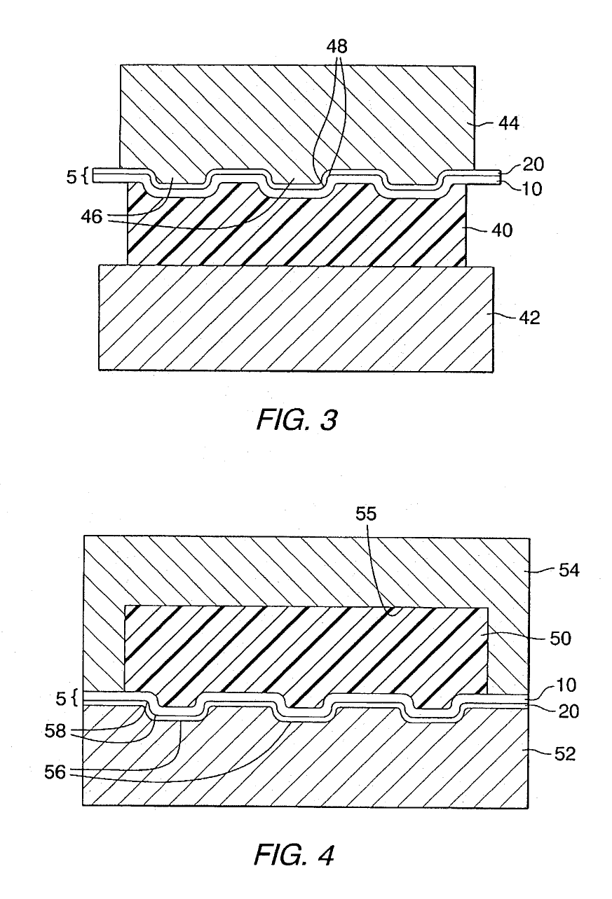

FIG. 3 illustrates a compression molding process utilizing a coated microporous sheet 5 in accordance with an embodiment of the present invention. A microporous sheet 10 with a coating 20 of the present invention is placed on a substrate material 40 such as plastic. The coated microporous sheet 5 may be placed on the substrate in the form of a substantially flat sheet. The substrate 40 is positioned on a lower press mold 42. An upper press mold 44 including mold features 46 is pressed against the coating 20, microporous sheet 10 and substrate 40. The upper press mold 44 deforms the coated microporous sheet 5 and substrate 40 to form a contoured coating layer on the contoured substrate. Alternatively, the coated microporous sheet 5 may be adhered to the upper press mold 44 by any suitable means such as a vacuum, then pressed against the substrate 40. The upper press mold 44 and/or the substrate 40 may be heated to a suitable temperature, such as from about 100 to about 200° C., depending on the particular substrate material being molded. When the coating 20 includes cross-linkers, the heat generated by the upper press mold 44 may be used to complete the cross-linking function. Standard molding pressures may be used. It will be appreciated that substrate 40 in FIG. 3 is shown as a substantially finished piece that is softened with heat and/or pressure, but the substrate can also be molten.

In one embodiment, the coated microporous sheet 5 adheres to the substrate 40 during the compression molding process without the use of adhesives. Alternatively, an adhesion promoter may be used between the coated microporous sheet and the substrate. In this case, a layer of adhesion promoter may be pre-applied to the microporous sheet on the opposite side from the coating, or onto the substrate itself. This may be particularly useful for wood-based substrates. Standard adhesion promoters, such as urea-formaldehyde or melamine-urea-formaldehyde adhesion promoters, can be used.

As shown in FIG. 3, during the compression molding process, the mold features 46 of the upper press mold 44 create high-draw deformation regions 48 in the coating 20 and microporous sheet 10. The deformation regions 48 are areas where the coated microporous sheet 5 undergoes substantial elongation. In some high-draw molding operations, elongations of 50 or 100 percent, or higher, may be experienced. The ability of the coated microporous sheets of the present invention to withstand substantial elongation allows for their use in many high-draw, in-mold processes.

FIG. 4 illustrates an injection molding process utilizing a coated microporous sheet in accordance with another embodiment of the invention. A microporous sheet 10 with a coating 20 of the present invention is placed on a first mold section 52. The coated microporous sheet 5 is typically placed on the first mold section 52 in the form of a substantially flat sheet. A second mold section 54 is secured to the first mold section 52, forming a mold chamber 55 above the coated microporous sheet 5. A substrate material 50 such as plastic is injected into the mold chamber 55, typically at an elevated temperature. The injected substrate material 50 fills the mold chamber 55 and forces the coated microporous sheet 5 into mold features 56 on the surface of the first mold section 52. Deformation regions 58 are thus created in the coated microporous sheet 5 in which the coated sheet is substantially elongated.

### EXAMPLES

The following examples are intended to illustrate various aspects of the present invention and are not intended to limit the disclosure or claims of the invention.

### Example 1

Several commercial solvent-based coating materials and several water-based coating compositions were spray-applied to Tesling® TS1000 microporous sheets and cured. Mechanical properties of the coated sheets were evaluated using an Instron Mini 44 unit with a crosshead speed of 25 mm/min. Mechanical testing was performed on samples having lengths of 76.2 mm and widths of 6.4 mm, with a test gauge length of 25.4 mm. Sample compositions, preparation procedures, and resulting mechanical properties are described in Tables 1 and 2. The film orientation of “machine” or “transverse” listed in the tables corresponds to the lengthwise direction or the widthwise direction, respectively, of the grain or extrusion direction of the microporous sheet. The term “elongation” means percentage elongation at break.

The solvent-based samples listed in Table 1 were selected for varying degrees of flexibility. In particular, the solvent-based Duranar® ADS sample contains a thermoplastic fluoropolymer. Similar chemistry is used in dry paint films due to its combination of flexibility, chemical resistance and exterior durability. As shown in Table 1, mechanical properties of the solvent-based coated microporous sheets were severely degraded compared to properties of the uncoated microporous sheets. On the other hand, as shown in Table 2, the water-based coating materials applied to the microporous sheets in accordance with the present invention did not result in the same degradation of mechanical properties.

TABLE 1
Mechanical Properties of Microporous Sheets Coated with Solvent-Based Materials

| | | Coating Cure/ | Coating | | Tensile | Tensile | |
|---|---|---|---|---|---|---|---|
| | Coating | Substrate Thermal | DFT | Film | Modulus | Strength | Elongation |
| Sample ID | Description | Treatment | (mil) | Orientation | (MPa) | (MPa) | (%) |
| 1 | DCU2042 | 20 min @ 180° F. | 2.3 ± 0.3 | Machine | 465 ± 128 | 13 ± 1 | 8 ± 3 |
| | Refinish | 16 hrs @ 120° F. | | Transverse | 371 ± 20 | 12 ± 1 | 9 ± 1 |
| | Clearcoat | | | | | | |
| 2 | TKU2000C | 20 min @ 180° F. | 2.0 ± 0.2 | Machine | 582 ± 135 | 13 ± 1 | 6 ± 1 |
| | APA Flexible | 16 hrs @ 120° F. | | Transverse | 445 ± 21 | 12 ± 1 | 11 ± 1 |
| | Clearcoat | | | | | | |
| 3 | Megaflon ® | 20 min @ 180° F. | 1.5 ± 0.2 | Machine | 507 ± 42 | 10 ± 1 | 4 ± 1 |
| | UMS10080 | 16 hrs @ 120° F. | | Transverse | 420 ± 69 | 9 ± 1 | 31 ± 5 |
| | Fluoropolymer | | | | | | |
| | Clearcoat | | | | | | |
| 4 | Duranar ® ADS | 20 min @ 180° F. | 1.5 ± 0.1 | Machine | 449 ± 117 | 6 ± 2 | 3 ± 1 |
| | UC60402 | 16 hrs @ 120° F. | | Transverse | 375 ± 23 | 6 ± 1 | 168 ± 8 |
| | Fluoropolymer | | | | | | (˜45)* |
| | (1 K) | | | | | | |
| 5 | Uncoated | — | — | Machine | 293 ± 20 | 5 ± 1 | 707 ± 80 |
| | Teslin ® TS1000 | | | Transverse | 178 ± 21 | 11 ± 1 | 858 ± 39 |
| 6 | Uncoated | 20 min @ 180° F. | — | Machine | 334 ± 25 | 5 ± 1 | 720 ± 68 |
| | Teslin ® TS1000 | | | Transverse | 250 ± 37 | 11 ± 1 | 833 ± 124 |
| 7 | Uncoated | 20 min @ 180° F. | — | Machine | 275 ± 24 | 5 ± 1 | 869 ± 183 |
| | Teslin ® TS1000 | 16 hrs @ 120° F. | | Transverse | 185 ± 6 | 10 ± 1 | 795 ± 124 |

Notes:
*Coating failure occurred prior to Teslin ® failure —value shown in parenthesis indicates elongation at coating failure.
Heating for 16 hrs @ 120° F. was required to remove solvent odor from coated Teslin ®.
DCU 2042, TKU2000C, and Duranar ® ADS are products of PPG Industries, Megaflon ® is a product of Keeler and Long, Inc.

TABLE 2
Mechanical Properties of Microporous Sheets Coated
with Water-Based Compositions

| | | Coating Cure/ | | | | | |
|---|---|---|---|---|---|---|---|
| | | Substrate | Coating | | Tensile | Tensile | |
| | Coating | Thermal | DFT | Film | Modulus | Strength | Elongation |
| Sample ID | Description | Treatment | (mil) | Orientation | (MPa) | (MPa) | (%) |
| 8 | Environ ® | 20 min @ 180° F. | ˜1.0 | Machine | 281 ± 11 | 4 ± 1 | 409 ± 44 |
| | 4MW42879 Coil | 16 hrs @ 120° F. | | | | | (˜200)* |
| | topcoat water- | | | Transverse | 281 ± 15 | 8 ± 1 | 526 ± 23 |
| | based acrylic | | | | | | (˜400%)* |
| | melamine | | | | | | |
| 9 | Envirobase ® T403 | 20 min @ 180° F. | ˜1.0 | Machine | 272 ± 18 | 4 ± 1 | 669 ± 81 |
| | Refinish basecoat | 16 hrs @ 120° F. | | | | | (˜175)* |
| | water-based acrylic | | | Transverse | 260 ± 31 | 9 ± 1 | 742 ± 94 |
| | | | | | | | (˜400)* |
| 10 | Witcobond ® | 20 min @ 180° F. | ˜0.5 | Machine | 275 ± 8 | 6 ± 1 | 382 ± 12 |
| | W-234 Water- | 16 hrs @ 120° F. | | Transverse | 204 ± 31 | 9 ± 1 | 478 ± 44 |
| | based polyurethane | | | | | | |
| | resin dispersion | | | | | | |
| 11 | Witcobond ® | 20 min @ 180° F. | ˜1.0 | Machine | 258 ± 23 | 9 ± 1 | 472 ± 65 |
| | W-234 Water- | 16 hrs @ 120° F. | | Transverse | 166 ± 4 | 13 ± 1 | 545 ± 65 |
| | based polyurethane | | | | | | |
| | resin dispersion | | | | | | |
| 12 | Uncoated Teslin ® | — | — | Machine | 293 ± 20 | 5 ± 1 | 707 ± 80 |
| | TS1000 | | | Transverse | 178 ± 21 | 11 ± 1 | 858 ± 39 |

Notes:
*Coating failure occurred prior to Teslin ® failure —values shown in parentheses indicate elongation at coating failure.
Environ ® and Envirobase ® are commercially available products of PPG Industries, Inc.
Witcobond ® W-234 is a commercially available product of Witco Corporation.

### Example 2

This example illustrates the preparation of a relatively high molecular weight polyurethane. A reaction vessel equipped with stirrer, thermocouple, condenser and nitrogen inlet was charged with 1010.3 g polytetramethylene ether glycol sold under the designation TERATHANE 2000 and 50.7 g dimethylolpropionic acid and heated to 60° C. 336.7 g isophorone diisocyanate was added over 10 minutes followed by 356.2 g methyl ethyl ketone and 1.51 g dibutyltin dilaurate. The reaction exothermed to 63° C. The reaction temperature was raised to 80° C. and the contents were stirred until the isocyanate equivalent weight was 1380. Then 39.4 g dimethylolpropionic acid was added to the reaction flask. The contents were stirred until the isocyanate equivalent weight was 2094.

The resultant product had a solids content of 83.4 weight percent (measured for one hour at 110° C.), an acid value of 21.20 mg KOH/g and a weight average molecular weight of 14971 in THF. 1552.0 g of above prepolymer at 76° C. was added over 25 minutes to a solution of 2259.9 g deionized water, 40.6 g adipic acid dihydrazide and 52.2 g dimethyl ethanol amine stirring at 21° C. and at 500 rpm in a cylindrical gallon reaction flask equipped with baffles, double pitched bladed stirrer, thermocouple and condenser. The dispersion temperature after this addition was 36° C. The reaction contents were stirred until no evidence of isocyanate was observed by FTIR.

This dispersion was transferred to a flask equipped with a stirrer, thermocouple, condenser and a receiver. The dispersion was heated to 60° C. and methyl ethyl ketone and water were removed by vacuum distillation.

The final dispersion has a solids content of 38.7 weight percent (measured from one hour at 110° C.), a Brookfield viscosity of 144 centipoise using a #2 spindle at 60 rpm, an acid content of 0.171 meq acid/g, a base content of 0.177 meq base/g, a pH of 8.26, a residual methyl ethyl ketone content of 0.15 weight percent and a weight average molecular weight of 95536 in DMF.

A coating comprising the resin prepared in Example 2 was made by mixing with a water-base yellow tint and spray applied to Teslin PS1000. Mechanical properties were tested as described in Example 1 with the following results: tensile modulus (MPa): 245±10 (machine), 126±24 (transverse); tensile strength (MPa): 6±1 (machine), 14±1 (transverse); and elongation (%): 974±91 (machine), 1,063±43 (transverse).

### Example 3

This example illustrates the preparation of a relatively high molecular weight polyurethane using a lower molecular weight polyether diol. A reaction vessel equipped with stirrer, thermocouple, condenser and nitrogen inlet was charged with 1447.3 g polytetramethylene ether glycol having a molecular weight of about 1,000 sold under the designation TERATHANE 1000 and 145.4 g dimethylolpropionic acid and heated to 60° C. 965.3 g isophorone diisocyanate was added over 13 minutes followed by 637.5 g methyl ethyl ketone and 4.34 g dibutyltin dilaurate. The reaction exothermed to 72° C. The reaction temperature was raised to 80° C. and the contents were stirred until the isocyanate equivalent weight was 923.5. Then 114.0 g dimethylolpropionic acid was added to the reaction flask. The contents were stirred until the isocyanate equivalent weight was 1430.2.

1512.2 g of above prepolymer 75° C. was added over 16 minutes to a solution of 2201.9 g deionized water, 58 g adipic acid dihydrazide and 76.2 dimethyl ethanol amine stirring at 25° C. and at 515 rpm in a cylindrical gallon reaction flask equipped with baffles, double pitched bladed stirrer, thermocouple and condenser. The dispersion temperature after this addition was 40° C. The reaction contents were stirred until no evidence of isocyanate was observed by FTIR. This dispersion was transferred to a flask equipped with a stirrer, thermocouple, condenser and a receiver. The dispersion was heated to 50° C. and methyl ethyl ketone and water were removed by vacuum distillation.

The final polyurethane dispersion has a solids content of 37.48 weight percent (measured for one hour at 110° C.), a Brookfield viscosity of 1450 centipoise using a #3 spindle at 60 rpm, an acid content of 0.240 meq acid/g, a base content of 0.247 meq base/g, a residual methyl ethyl ketone content of 1.16 weight percent and a weight average molecular weight of 77274 in DMF.

Water-based coating compositions using the resin produced as described in Example 3 are described in Table 3.

TABLE 3
Coating Compositions Containing
Solvent-Free Polyurethane Dispersions

SAMPLE ID

| Ingredient | 13 | 14 | 15 | 16 |
|---|---|---|---|---|
| Example 3 Resin | 60.95 | 64.22 | 72.34 | 55.94 |
| OneSource 9292- | 16.05 | — | — | — |
| S893 Tint (Yellow | | | | |
| Oxide) | | | | |
| OneSource 9292- | — | 22.50 | — | — |
| R3817 Tint | | | | |
| (Organic Red) | | | | |
| OneSource 9292- | — | — | 6.00 | — |
| B3546 Tint (Lamp | | | | |
| Black) | | | | |
| OneSource 9292- | — | — | — | 30.00 |
| Y724 Tint (Yellow | | | | |
| H3G) | | | | |
| Carbodilite ® V02- | — | — | 21.66 | 14.06 |
| L2 (poly | | | | |
| carbodiamide cross- | | | | |
| linker) | | | | |
| Cymel ® 385 | 3.25 | 3.29 | — | — |
| (melamine cross- | | | | |
| linking agent) | | | | |
| DI Water | 19.75 | 9.99 | — | — |
| Total | 100.00 | 100.00 | 100.00 | 100.00 |

Notes:
OneSource 9292-S893 Tint, OneSource 9292-R3817 Tint, OneSource 9292-Y724 Tint and OneSource 9292-B3546 Tint are commercially available products of PPG Industries, Inc.
Carbodilite ® V02-L2 is a product of Nisshinbo Industries, Inc.
Cymel ® 385 is a commercially available product of Cytec Industries.

Samples 13 and 14 were spray applied to microporous sheets, as previously described. Alternatively, Samples 15 and 16 were applied to rolls of microporous sheets using a continuous operation. Liquid coating was pumped through a die and applied to a continuous web of Teslin® SP700 microporous sheet using a slot coater. After application of the coating composition, the coated web was continuously thermally cured in an oven and coiled on a roll. Mechanical properties of the microporous sheet, coated with these formulations, are summarized in Table 4. Sample numbers 17-20 listed in Table 4 are uncoated Teslin®.

TABLE 4
Mechanical Properties of Microporous Sheets Coated with
Water-Based Polyurethane Dispersions

| | | Coating | | | | | | |
|---|---|---|---|---|---|---|---|---|
| | | Cure/ | | | | | | |
| | | Substrate | | Coating | | Tensile | Tensile | |
| | Coating | Thermal | Substrate | DFT | Film | Modulus | Strength | Elongation |
| Sample ID | Description | Treatment | Composition | (mil) | Orientation | (MPa) | (MPa) | (%) |
| 13 | Yellow | 5 min @ 180° F. | Teslin ® | 1.0-1.4 | Machine | 365 ± 2 | 7 ± 1 | 355 ± 34 |
| | Monocoat | | TS1000 | | Transverse | 331 ± 33 | 10 ± 1 | 468 ± 27 |
| 14 | Red | 5 min @ 180° F. | Teslin ® | 1.0-1.4 | Machine | 366 ± 28 | 7 ± 1 | 397 ± 52 |
| | Monocoat | | TS1000 | | Transverse | 300 ± 22 | 9 ± 1 | 526 ± 87 |
| 17 | Uncoated | — | Teslin ® | — | Machine | 293 ± 20 | 5 ± 1 | 707 ± 80 |
| | | | TS1000 | | Transverse | 178 ± 21 | 11 ± 1 | 858 ± 39 |
| 15 | Black | ˜1 min @ 250° F. | Teslin ® | ˜0.6 | Machine | 258 ± 23 | 9 ± 1 | 472 ± 65 |
| | Monocoat | | SP700 | | Transverse | 166 ± 4 | 13 ± 1 | 545 ± 65 |
| 16 | Yellow | ˜3 min @ 250° F. | Teslin ® | ˜0.9 | Machine | 258 ± 23 | 9 ± 1 | 472 ± 65 |
| | Monocoat | | SP700 | | Transverse | 166 ± 4 | 13 ± 1 | 545 ± 65 |
| 18 | Uncoated | — | Teslin ® | — | Machine | 381 ± 6 | 5 ± 1 | 669 ± 112 |
| | | | SP700 | | Transverse | 358 ± 44 | 12 ± 1 | 725 ± 94 |
| 19 | Uncoated | ˜1 min @ 250° F. | Teslin ® | — | Machine | 406 ± 4 | 5 ± 1 | 437 ± 138 |
| | | | SP700 | | Transverse | 408 ± 35 | 11 ± 1 | 603 ± 104 |
| 20 | Uncoated | ˜3 min @ 250° F. | Teslin ® | — | Machine | 425 ± 36 | 5 ± 1 | 493 ± 80 |
| | | | SP700 | | Transverse | 411 ± 21 | 11 ± 1 | 615 ± 74 |

Note:
No coating failure occurred prior to Teslin ® failure.

As shown in Tables 2 and 4, the microporous sheets coated with the water-based coatings of the present invention possess very good mechanical properties. For example, the present coated microporous sheets have elongations well over 50 percent, typically greater than 100 or 200 percent. In comparison, the microporous sheets coated with solvent-based coatings exhibit substantially lower elongations, even though some of the solvent-based coatings are conventionally considered to have high flexibility. The increased elongation properties of the present coated microporous sheets allow for their use in many applications such as high-draw in-mold laminated products.

### Example 4

Coated microporous-sheets were compression molded in the following manner. The coated microporous sheets were fixed to the surface of a water-cooled mold using adhesive. Molten polymer (>200° C.) was placed into the mold; the mold was closed; and pressured was applied (˜150 ton). The water-cooled mold surface rapidly solidified the article, forming a solid article in approximately 40 seconds. The coated microporous sheets were examined after the molding operation. In flat regions of the parts, the coated microporous sheets were bonded to the parts and remained intact, regardless of coating composition. However, in areas with a more complex geometry, e.g., raised lettering, edges, etc., the coated sheets undergo substantial deformation during the molding operation.

Table 5 lists the compression molding test results. Sample 21 comprises commercially available fluorourethane Megaflon MSFC Green from Keeler & Long.

TABLE 5
Compression Molding Results of Coated Microporous Sheets

| | | Compression Molding Results - |
|---|---|---|
| Sample ID | Coating Description | High Draw Regions |
| 1 | Basecoat/Clearcoat | Fail |
| | Solvent-Based | |
| 21 | Green Monocoat | Fail |
| | Solvent-Based | |
| 13 | Yellow Monocoat | Pass |
| | Water-Based | |
| 14 | Red Monocoat | Pass |
| | Water-Based | |

Only the water-based Samples 13 and 14 of the present invention, which showed minimal or no degradation of mechanical properties during tensile testing, remained intact (no cracking, loss of adhesion, etc.) in the high-draw areas of the molded article.

Whereas particular embodiments of this invention have been described above for purposes of illustration, it will be evident to those skilled in the art that numerous variations of the details of the present invention may be made without departing from the invention as defined in the appended claims.

What is claimed is:

1. A microporous sheet coated with a water-based resin coating comprising polyurethane.

2. The microporous sheet of claim 1, wherein the water-based resin coating is substantially solvent-free.

3. The microporous sheet of claim 1, wherein the polyurethane has an average molecular weight average of at least 25,000.

4. The microporous sheet of claim 1, wherein the coating further comprises a pigment, crosslinker, curing agent, filler, extender, UV absorber, light stabilizer, plasticizer, surfactant and/or wetting agent.

5. The microporous sheet of claim 1, wherein the coating further comprises a pigment.

6. The microporous sheet of claim 1, wherein the coating further comprises a cross-linker including a melamine, formaldehyde, carbodiimide and/or isocyanate.

7. The microporous sheet of claim 6, wherein the carbodiimide is a water-based carbodiimide.

8. The microporous sheet of claim 1, wherein the microporous sheet comprises a polymer matrix and at least about 30 weight percent filler particles.

9. The microporous sheet of claim 8, wherein the filler particles comprise at least 50 weight percent of the microporous sheet.

10. The microporous sheet of claim 1, wherein the microporous sheet comprises a polyethylene matrix.

11. The microporous sheet of claim 1, wherein the microporous sheet comprises silica filler particles.

12. The microporous sheet of claim 1, wherein the microporous sheet comprises from about 30 to about 95 volume percent pores.

13. The microporous sheet of claim 1, wherein the coating has a thickness of at least 0.2 mil.

14. The microporous sheet of claim 1, wherein the coating is applied directly on one side of the microporous sheet.

15. The microporous sheet of claim 1, further comprising a primer layer between the coating and the microporous sheet.

16. The microporous sheet of claim 1, further comprising a protective layer over at least a portion of the coating.

17. The microporous sheet of claim 1, further comprising an adhesive layer on a side of the microporous sheet opposite from the coating.

18. The microporous sheet of claim 1, wherein the coated microporous sheet has an elongation at break of at least 50 percent.

19. The microporous sheet of claim 1, wherein the coated microporous sheet has an elongation at break of at least 100 percent.

20. A coated microporous sheet comprising:
a microporous sheet; and
a coating over at least a portion of the microporous sheet, the coating having a dry film thickness of at least 0.1 mil, wherein the coated microporous sheet has an elongation of greater than 50 percent.

21. The coated microporous sheet of claim 20, wherein the coating comprises a substantially solvent-free, waterbased resin.

22. The coated microporous sheet of claim 21, wherein the resin comprises polyurethane, acrylic, polyester, polyether, polycarbonate, polyamide, epoxy and/or vinyl.

23. The coated microporous sheet of claim 21, wherein the coating further comprises a pigment, crosslinkers, fillers, extenders, UV absorbers, light stabilizers, plasticizers, surfactants, thickeners and/or wetting agents.

24. The coated microporous sheet of claim 20, wherein the microporous sheet comprises a polymer matrix and at least about 50 weight percent silica filler particles.

25. The coated microporous sheet of claim 20, wherein the microporous sheet comprises from about 30 to about 95 volume percent pores.

26. A method of coating a microporous sheet, the method comprising applying a substantially solvent-free, water-based urethane resin coating composition on the microporous sheet.

27. The method of claim 26, wherein the coating composition is applied by spraying, slot coating, roll coating, curtain coating, screen printing or rod coating.

28. The method of claim 26, wherein the coating composition when cured has a dry film thickness of at least 0.1 mil.

29. The method of claim 26, wherein the coating composition is applied directly on one side of the microporous sheet.

30. The method of claim 26, further comprising applying a primer layer between the coating and the microporous sheet.

31. The method of claim 26, further comprising applying a protective layer over at least a portion of the coating.

32. The method of claim 26, further comprising applying an adhesive on a side of the microporous sheet opposite from the coating.

33. The method of claim 26, wherein the coating composition comprises less than 15 weight percent organic solvent.

34. The method of claim 26, wherein the coating composition comprises less than 5 weight percent organic solvent.

35. The method of claim 26, wherein the coating composition comprises from about 20 to about 80 weight percent water.

36. The method of claim 26, wherein the coating composition comprises from about 5 to about 60 weight percent of the resin.

37. The method of claim 26, wherein the coating composition further comprises a pigment, crosslinkers, fillers, extenders, UV absorbers, light stabilizers, plasticizers, surfactants, thickeners and/or wetting agents.

38. The method of claim 26, wherein the coating composition further comprises a pigment.

39. The method of claim 26, wherein the coating composition further comprises a cross-linker including a melamine, formaldehyde, carbodiimide and/or isocyanate.

40. The method of claim 26, wherein the microporous sheet comprises a polymer matrix and at least about 50 weight percent silica filler particles.

41. The method of claim 26, wherein the microporous sheet comprises from about 30 to about 95 volume percent pores.

42. A laminated article comprising:
a substrate; and
a microporous sheet coated with a water-based resin coating adhered to the substrate.

43. The laminated article of claim 42, wherein the substrate comprises a polymer.

44. The laminated article of claim 42, wherein the coated microporous sheet is adhered directly to the substrate without an adhesive layer.

45. The laminated article of claim 42, wherein at least a portion of the coated microporous sheet has been elongated.

46. The laminated article of claim 45, wherein the elongation is at least 10 percent.

47. The laminated article of claim 45, wherein the elongation is at least 50 percent.

48. The laminated article of claim 45, wherein the elongation is at least 100 percent.

49. The laminated article of claim 42, wherein the microporous sheet comprises a coating including a resin comprising polyurethane, acrylic, polyester, polyether, polycarbonate, polyamide, epoxy and/or vinyl.

50. The laminated article of claim 42, wherein the microporous sheet comprises a polymer matrix and at least about 50 weight percent silica filler particles.

51. The laminated article of claim 42, wherein the microporous sheet comprises from about 30 to about 95 volume percent pores.

52. A method of making a laminated article, the method comprising:
providing a substrate material; and
adhering a microporous sheet coated with a water-based resin coating to the substrate.

53. The method of claim 52, further comprising molding the substrate material.

54. The method of claim 53, wherein the substrate material is molded by compression molding or injection molding.

55. The method of claim 52, wherein the coated microporous sheet is adhered directly to the substrate without an adhesive layer.

56. The method of claim 52, wherein at least a portion of the coated microporous sheet is elongated during the adhering step.

57. The method of claim 56, wherein the elongation is at least 10 percent.

58. The method of claim 56, wherein the elongation is at least 50 percent.

59. The method of claim 56, wherein the elongation is at least 100 percent.

60. The method of claim 52, wherein the microporous sheet comprises a coating including a resin comprising polyurethane, acrylic, polyester, polyether, polycarbonate, polyamide, epoxy and/or vinyl.

61. The method of claim 52, wherein the microporous sheet comprises a polymer matrix and at least about 50 weight percent silica filler particles.

62. The method of claim 52, wherein the microporous sheet comprises from about 30 to about 95 volume percent pores.

63. The microporous sheet of claim 1, wherein the microporous sheet comprises a synthetic polymer matrix.

64. The laminated article of claim 48, wherein the microporous sheet comprises a synthetic polymer matrix and filler particles.
